(19) United States
(12) Patent Application Publication
(10) Pub. No.: US 2024/0114195 A1
(43) Pub. Date: Apr. 4, 2024

(54) Managing the reading of a multimedia content item

(71) Applicant: ORANGE, Issy-les-Moulineaux (FR)

(72) Inventors: Mathieu Rivoalen, CHATILLON CEDEX (FR); Hervé Marchand, CHATILLON CEDEX (FR)

(21) Appl. No.: 18/475,454

(22) Filed: Sep. 27, 2023

(30) Foreign Application Priority Data
Sep. 29, 2022 (FR) 2209867

(51) Int. Cl. H04N 21/43

(52) U.S. Cl. CPC H04N 21/43076

(57) ABSTRACT

A method for managing, in a terminal, the reading of a multimedia content item, referred to as a main content item, with a view to rendering it. The content item includes time segments which may be received from a communication network. The reading of the main content item is interspersed with a reading of a multimedia content item, referred to as a secondary content item. The method further includes: requesting access to the main content item; detecting an interval between the instant at which a segment of the main content item is rendered and a reference instant at which the same segment is rendered; and modifying the reading speed used by the terminal when the secondary content item is read.

### TECHNICAL FIELD

The field of the present disclosure is that of managing the rendering of digital multimedia content items, namely digital audio and/or video content items. More specifically, the disclosure relates to managing the rendering of a multimedia content item.

The disclosure most particularly targets content items which may be rendered at different instants depending on a state of the communication network. In the examples described below, such a content item is a content item which is accessible in several formats which are associated with respective sizes in bytes having more or less impact on the bandwidth of the network over which the content item is downloaded. The disclosure most particularly targets content items downloaded according to a HTTP adaptive streaming, or HAS, technique or any other download technique using the same principle.

The disclosure is of particular interest in a system in which the same content item is rendered on several rendering devices belonging to users who interact with one another in real time when the content item is rendered. The interaction may, for example, be carried out by means of a camera and of rendering the participants on the various rendering devices. The interaction may also be made with landline phones or cell phones.

The disclosure is not limited to the embodiment targeted above. The disclosure is also of interest to users in search of an optimal duration between an event (football match, etc.) and the rendering of this event on a rendering device; for example, content items broadcast live are some of the content items for which there is a desire to reduce the duration between the instant at which they are broadcast from a server and the instant at which they are rendered on a screen as much as possible. In other words, the disclosure offers the possibility of reducing the time interval between the live broadcast and the rendering on a rendering device as much as possible, which time interval may be due to lower performance of the telecommunications network used.

### PRIOR ART

Nowadays it is possible for the majority of terminals to access a multimedia content item, such as television or video on demand, from the Internet, notably when they belong to a local area communication network, such as a home network.

The terminal generally sends a request to a server, indicating the chosen content item; in return the terminal receives a stream of digital data relating to this content item. In the context of a local area communication network, such a request transits via the access gateway to the network, for example the residential gateway.

The terminal is designed to receive a digital content item in the form of multimedia data and to request for this content item to be rendered on a rendering device. Data received corresponding to a video are generally decoded, then rendered in the form of displaying the corresponding video with its associated soundtrack. Below, for the sake of simplification, the digital content item will be identified with a video and being rendered by the terminal, or consumed by the user of the terminal, with being viewed on the screen of the terminal.

Digital content items are often broadcast over the Internet based on client-server protocols of the HTTP (Hypertext Transport Protocol) family. In particular, streaming digital content items makes it possible to transport and consume the data in real time, that is to say that the digital data are transmitted over the network and rendered by the terminal as and when they arrive. The terminal receives and stores some of the digital data in a buffer memory before rendering them. This distribution mode is particularly useful when the bit rate which is available to the user is not guaranteed for the real-time transfer of the video.

HTTP adaptive streaming, abbreviated to HAS, additionally makes it possible to broadcast and receive data at various qualities corresponding, for example, to various bit rates. These various qualities are described in a manifest which is available to download from a data server, for example a content server. When the client terminal desires to access a content item, this manifest makes it possible to select the correct format for the content item to be consumed depending on the available bandwidth or on the storage and decoding capacities of the client terminal. This type of technique notably makes it possible to take variations in bandwidth over the link between the client terminal and the content server into account.

There are several technical solutions for making it easier to distribute such a content item through streaming, such as, for example, the proprietary solutions Microsoft® Smooth Streaming, Apple® HLS, Adobe® HTTP Dynamic Streaming or indeed the MPEG-DASH standard of the ISO/IEC organization, which will be described below. These methods propose to address one or more manifests to the client, which contain the addresses of the various segments at the various qualities of the multimedia content item.

Thus, the MPEG-DASH (Dynamic Adaptive Streaming over HTTP) standard is a format standard for audiovisual broadcasting over the Internet. It is based on preparing the content item in various versions of variable bit rate and quality, which are divided into segments of short duration (of the order of a few seconds), which are also called segments. Each of these segments is made available individually by means of an exchange protocol. The protocol which is mainly targeted is the HTTP protocol, but other protocols (for example FTP) may also be used. The organization of the segments and the associated parameters are published in a manifest in XML format.

The principle underlying this standard is that the client terminal estimates the bandwidth which is available to receive segments, and, depending on how full its receiving buffer is, chooses, for the next segment to be loaded, a version the bit rate of which ensures the best possible quality, and makes possible a receiving delay which is compatible with rendering the content item uninterruptedly.

Thus, in order to adapt to variation in network conditions, notably in terms of bandwidth, existing adaptive streaming solutions make it possible for the client terminal to move from one version of the content item, encoded at a certain encoding bit rate, to another, encoded at another bit rate, during download. Specifically, each version of the content item is divided into segments of the same duration. In order to make it possible to render the content item continuously on the terminal, each segment must reach the terminal before the instant at which it is scheduled to be rendered. The perceived quality associated with a segment increases with the size of the segment, expressed in bits, but, at the same time, larger segments require a longer transmission time, and therefore are at a higher risk of not being received in time for the content item to be rendered continuously.

The rendering terminal therefore must find a compromise between the overall quality of the content item and rendering it uninterruptedly, by carefully selecting the next segment to be downloaded from among the various proposed encoding bit rates. There are, for this purpose, various algorithms for selecting the quality of the content item depending on the available bandwidth, which may have more or less aggressive or more or less secure strategies.

On the other hand, the terminal receives and stores some of the digital data in a buffer memory before rendering them. This distribution mode is particularly useful when the bit rate which is available to the user is not guaranteed for the real-time transfer of the video, depending, for example, on the fluctuation in available bandwidth.

Specifically, such a fluctuation may induce a variation in latency over time, which is called jitter. It will be recalled that latency is defined, in a data transmission network, as the time which is necessary for a data packet to be rendered. This latency time is generally calculated by taking the instant at which a packet is broadcast by a broadcast server as the initial instant and the instant at which it is rendered as the final instant. During this latency time, the packet moves from the source to the destination through the network, until the data of the packet are rendered. In order to compensate for the detrimental effects of jitter for the user, it is known practice to place a buffer memory in the terminal for rendering the received data streams, in which a certain number of data packets are stored, before they begin to be rendered to the user. This jitter buffer therefore induces a delay which may be detected at the beginning of the rendering of the stream.

This time interval is not desirable when the content item is a live content item, in particular when it relates to a large-scale event such as a sports fixture, for example a football match.

Furthermore, such operation, which is the same in each rendering terminal, poses a problem, in particular in a context in which several people interact in real time with regard to a rendered content item. Specifically, the networks to which the rendering terminals are connected, respectively, have characteristics which may differ; in particular, bandwidth differs from one network to another; buffer sizes (also called depths) also differ. The result of these differences, for the same live content item, is a time interval between instants at which segments are rendered on the various televisions which may sometimes be of the order of ten to fifteen seconds. This interval is very disadvantageous when several users view and comment on this same live content item, for example during a videoconference. For example, in the case of a football match, action may unfold with ten seconds of time difference between two renderings; real-time interaction then becomes impossible because of the time interval.

One or more exemplary aspects of the present disclosure aim to improve the situation.

### SUMMARY

An aspect of the present disclosure relates to a method for managing, in a terminal, the reading of a multimedia content item (C1), referred to as the main content item, with a view to rendering it, a content item comprising time segments which may be received from a communication network (RES), the reading of the main content item being interspersed with a reading of a multimedia content item, referred to as the secondary content item, characterized in that it comprises
a. requesting access to the main content item;
b. detecting an interval between the instant at which a segment of the main content item is rendered and a reference instant at which the same segment is rendered;
c. modifying the reading speed used by the terminal when the secondary content item is read.

By modifying the reading speed, an aspect of the present disclosure makes it possible to correct for any time intervals which have arisen when the segments were read because, for example, of interference on the communication network from which the segments are downloaded.

It will be seen, in one embodiment, that, when a delay is detected between an instant at which a segment is rendered on a first terminal and a reference instant, an aspect of the present disclosure makes it possible to accelerate, or decelerate, the reading of the received segments and thus makes it possible to reduce a time interval between a broadcast event and the rendering of this event on a rendering device.

Furthermore, in a context in which several people interact in real time with regard to the rendered content item, an aspect of the present disclosure makes it possible to reduce a time interval between various renderings to a reasonable interval value, or even a null time interval. In this way, reactions or comments made in real time by participants viewing the same scene of a content item are carried out without a time interval, or at worst with an acceptable time interval. The result of this synchronization between renderings is a greatly improved user experience.

According to an aspect of the present disclosure, the speed is modified in connection with the secondary content item. Furthermore, the modification of the speed may be applied only to part of this secondary content item. The modification relates to a secondary content item other than the content item currently being read; this secondary content item may be, for example, an unrequested content item, unlike the main content item, which is the subject of an access request originating from the terminal; or even an undesired content item such as an advertisement. It will be seen below that, when several secondary content items, for example several advertisements, are read successively by the reading terminal, the modification of the speed may relate only to some of the advertisements, for example depending on the tastes/preference of the user.

It is specified here, as indicated below, that the reference rendering instant relates equally well to an instant of rendering on another terminal, or to a predicted rendering instant, or to any other relevant instants making it possible to detect an abnormal time delay in connection with a rendering of a content item.

It should be noted that, as will be seen below in one embodiment, the predicted rendering instant is stored in the manifest associated with the content item; this manifest will therefore be referred to in order to obtain the expected rendering instant.

According to a first embodiment of the method, the speed is modified in connection with part of the secondary content item. In this embodiment, the acceleration relates only to part of the content item to be read, preferably to a part of no great interest to the user. A part of no interest is, for example, the opening or closing credits, or a scene of a video of no importance, etc.

According to another, second particular implementation of the disclosure, which may be implemented as an alternative or in addition to the previous one, the speed used depends on the secondary content item to be read. For example, if the secondary content item is an advertisement, another speed will be used. In this way, even if the chosen acceleration was perceptible to the user, accelerated rendering would have no negative impact on the user because it would be implemented on a secondary content item which was not requested by the user, or even undesired.

According to another, third particular implementation of the disclosure, which may be implemented as an alternative or in addition to the previous ones, if the secondary content item is yet to be rendered, the method comprises postponing modifying the reading speed. This implementation targets the case where the secondary content item has not begun to be rendered. The postponement makes it possible to read the main content item normally without altering the reading of it and to apply the modification later, namely when the secondary content item is read.

According to another, third particular implementation of the disclosure, which may be implemented as an alternative or in addition to the previous ones, the reference instant is an instant at which the same segment is rendered on another terminal. This implementation targets the case of a conference during which a discussion takes place in relation to the content item which is rendered simultaneously on the various screens. This implementation makes it possible to synchronize the rendering of the content item on several rendering devices.

According to another, third particular implementation of the disclosure, which may be implemented as an alternative or in addition to the previous ones, the reference instant is a predicted instant at which the same segment is rendered. This implementation targets the case where the aim is to be as close as a predicted rendering instant calculated by a content broadcaster. The content item in question may be, for example, a live broadcast. This implementation makes it possible to be as close as possible to live.

According to one hardware aspect, an aspect of the present disclosure relates to an entity for managing the reading of a multimedia content item, referred to as the main content item, with a view to rendering it, a content item comprising time segments which may be received from a communication network, the reading of the main content item possibly being interspersed with a reading of a multimedia content item, referred to as the secondary content item, characterized in that it comprises
a. a mode which is able to request access to the main content item;
b. a detection module which is able to detect an interval between the instant at which a segment of the main content item is rendered and a reference instant at which the same segment is rendered,
c. a modification module which is able to modify the reading speed used by the terminal when the secondary content item is read, when an interval is detected.

According to another hardware aspect, the disclosure relates to a reading terminal comprising a management entity as defined above.

According to another hardware aspect, one subject of the disclosure is a computer program which may be implemented on a management entity as defined above, the program comprising code instructions which, when it is executed by a processor, carries out the steps of the management method which are defined above.

According to another hardware aspect, one subject of the disclosure is a data medium on which at least one series of program code instructions for executing a management method as defined above has been stored.

The medium in question may be any entity or device which is capable of storing the program. For example, the medium may comprise a storage means, such as a ROM, for example a CD-ROM or a microelectronic circuit ROM, or indeed a magnetic storage means, for example a hard disk. Moreover, the information medium may be a transmissible medium such as an electrical or optical signal, which may be routed via an electrical or optical cable, by radio or by other means. The program according to the disclosure may be, in particular, downloaded over the Internet. Alternatively, the data medium may be an integrated circuit into which the program is incorporated, the circuit being designed to execute or to be used in the execution of the method in question.

### BRIEF DESCRIPTION OF THE DRAWINGS

One or more aspects of the present disclosure will be better understood on reading the following description, which is given by way of example and with reference to the appended drawings, in which:

FIG. 1 shows an architecture for streaming over the Internet based on the use of HTTP adaptive streaming according to one embodiment of the method of the disclosure;

FIG. 2 schematically illustrates the hardware structure of a master terminal for reading multimedia streams;

FIG. 3 schematically illustrates the hardware structure of a slave terminal for reading multimedia streams in real time;

FIG. 4 illustrates a content item and the segments which are available for this content item;

FIG. 5 illustrates the steps of one embodiment;

FIG. 6 illustrates prior art illustrating time axes and a reading of content items on two different reading terminals during a videoconference; this figure illustrates the fact that a time interval appearing at a given instant has repercussions on the entire reading of the content item;

FIG. 7 illustrates one possible embodiment of the method of the disclosure, according to which a management entity implements an algorithm to reduce, or even remove, a time interval between a rendering instant and a reference instant and thus ensure an optimal user experience.

### DETAILED DESCRIPTION OF ILLUSTRATIVE EMBODIMENTS OF THE DISCLOSURE

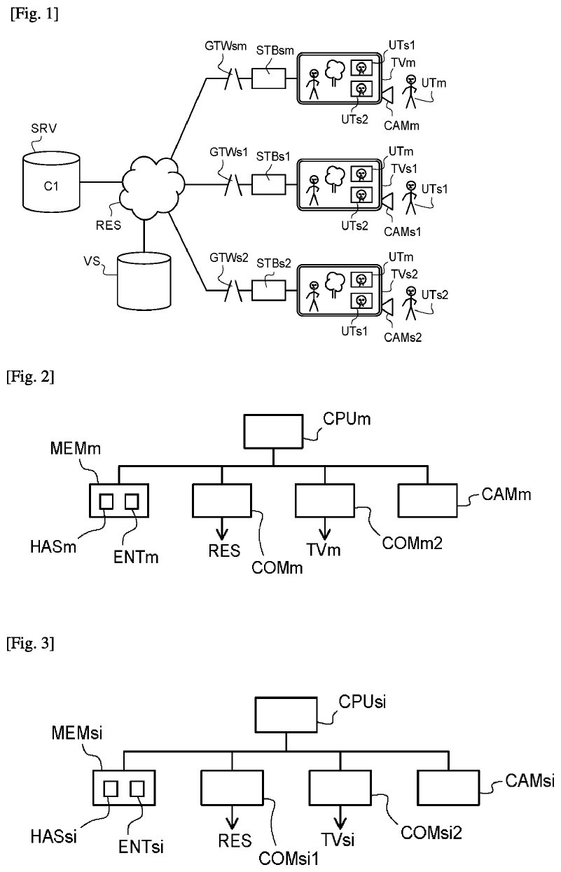

An architecture for downloading a multimedia content item will now be presented with reference to FIG. 1.

In this example, the download is streaming based on the use of HTTP adaptive streaming (HAS). It is specified again here that aspects of the disclosure are not limited to HAS technology, but extend to any other technologies for downloading data.

A digital content server SRV is located, according to this example, in the wide area network (WAN), labeled RES, but it might equally well be located a residential gateway or any other equipment which is capable of hosting such a content server.

The content server SRV receives, for example, channels of digital television content items originating from a broadcast television network, which is not shown, and/or videos on demand, and makes them available to client terminals.

Client reading terminals, for example set-top boxes STBm/STBsi, may enter into communication with the content server SRV in order to receive one or more content items (films, documentaries, advertising sequences, etc.).

The client terminals may be of any kind, for example a set-top box STB, a computer PC, a cell phone MOB, etc.

The embodiments will be based on set-top boxes equipped with a rendering device such as a television.

As will be seen later, in this example, a master client terminal STBm (the index “m” designates this master client terminal) will be distinguished from slave client terminals STBsi (“s” designates a slave client terminal and “i” the nth terminal; the index “i” is an integer and designates a terminal “i” in particular). The disclosure is not limited to this example; an aspect of the present disclosure may also be implemented with a single set-top box, or when several set-top boxes are present without a master/slave hierarchical relationship.

In this example, the master set-top box will serve as a reference for determining a reference rendering instant. The slave set-top boxes will rely on this reference rendering instant in order to detect an abnormal time delay (or time interval).

In this client-server context, an HTTP adaptive streaming technique, abbreviated to HAS, is frequently used to exchange data between a client terminal STBm/STBsi and the server SRV. This type of technique notably makes it possible to offer the user good content quality by taking into account variations in bandwidth which may occur over the link between the client terminal and a service gateway, and/or between the latter and the content server SRV.

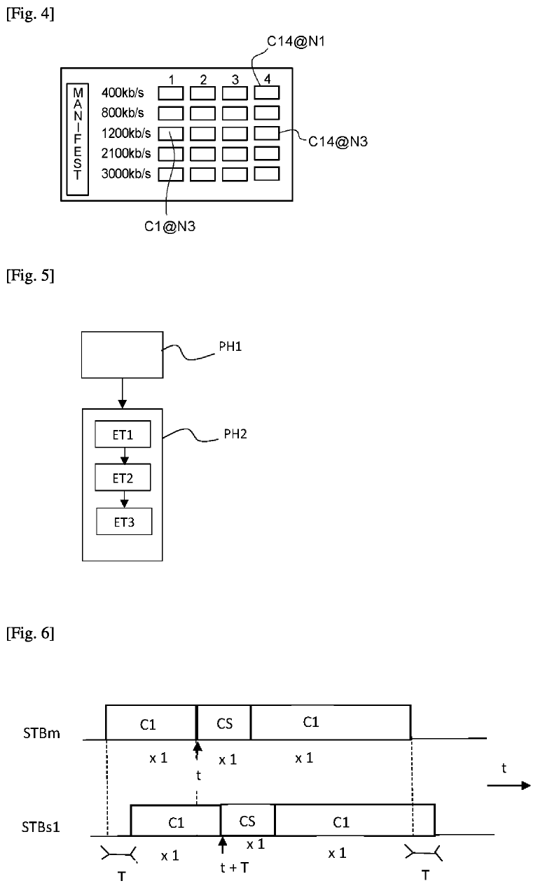

Conventionally, as will be seen with reference to FIG. 4, various qualities may be encoded for the same content item of a channel, corresponding, for example, to various encoding bit rates. More generally, the term “quality” will be used to refer to a certain resolution of the digital content item (spatial resolution, temporal resolution, quality level associated with the video and/or audio compression) with a certain encoding bit rate. Each quality level is itself divided, on the content server, into time segments (also called content “segments” by a person skilled in the art).

The description of these various qualities and of the associated temporal segmentation, as well as the content segments, are described to the client terminal and made available to it via their Internet addresses (URI: Universal Resource Identifier). All of these parameters (qualities, addresses of the segments, etc.) are generally grouped together in a parameter file, referred to as the manifest. It will be noted that this parameter file may be a computer file or a set of information describing the content item, which is accessible at a certain address.

The reading terminal STBm or STBsi may, in an HTTP adaptive streaming context, adapt the access requests which it transmits to the server in order to receive and decode the content item requested by the user at the quality which best corresponds to it. In this example, if the content items are available at bit rates of 400 kb/s (kilobits per second) (resolution 1, or level 1, labeled N1), 800 kb/s (N2), 1200 kb/s (N3), 2100 kb/s (N4) and 3000 kb/s (N4) and if the client terminal has available a bandwidth of 3000 kb/s, it may request the content item at any bit rate which is lower than this limit, for example 2100 kb/s. Generally, content item number i with quality j is labeled “Ci@Nj” (for example, the jth quality level Nj described in the manifest).

In this example, a service gateway GTWm/GTWsi, for example a residential gateway, may be interposed between the WAN and a client terminal. This gateway routes data between a wide area network WAN and a set-top box STB, and manages the digital content items by receiving them from the network and decoding them by virtue of the set-top box STB.

In this example, in order to view a content item, a client terminal STBm/STBsi firstly interrogates the service gateway to which it is connected in order to obtain an address of the manifest of the desired content item (for example, C1). The service gateway responds by delivering, to the terminal, the address of the manifest. It will be assumed below that this manifest is a manifest according to the MPEG-DASH standard.

Alternatively, this manifest may be retrieved directly from a local Internet server or an Internet server which is external to the local area network, or already be located in the service gateway or in the terminal at the moment of the request.

An example of a manifest, which will be described below with reference to FIG. 4, comprises the description of content items which are available at several different qualities (N1=400 kb/s, N2=800 kb/s, N3=1200 kb/s, etc.).

Once it has the addresses of segments corresponding to the desired content item, the service gateway under consideration obtains the segments by downloading them from these addresses. It will be noted that this download is made here, conventionally, via an HTTP URL, but might also be made via a Universal Resource Identifier (URI) describing another protocol (dvb://mycontentsegment, for example).

The set-top box STBm/STBsi is used to render a television program on a screen of a television TVm/TVsi, respectively. This television program will be designated by the name “content item C1” below.

As a variant, it will be noted that the content item C1 may be a pre-recorded television program, or a video on demand, or a personal video of the user, or any other multimedia content item of a given duration, to which the disclosure also applies.

In this example, real-time communication takes place in parallel with the various renderings on the televisions TVm/TVsi. Any way to communicate between users in real time may be used. In this example, communication will be carried out via cameras and by putting users in a picture-in-picture on the various screens of the televisions. In this example, on the master television TVm, the users UTs1 and UTs2 appear in the picture-in-picture. On the slave television TVs1, the users UTm and UTs2 appear in the picture-in-picture; and, on the master television TVs2, the users UTm and UTs1 appear in the picture-in-picture.

A set-top box STBm/STBsi (i is an integer) may be controlled by the user by means of a remote control (which is not shown). This remote control will make it possible to select tabs on a selection interface. A remote control may be a physical or software remote control.

FIG. 2 shows an architecture of a master client terminal STBm, illustrated by means of a set-top box according to one embodiment of the disclosure.

The set-top box STBm conventionally comprises memories MEMm associated with a processor CPUm. The memories may be ROMs (read-only memories) or RAMs (random-access memories) or indeed flash memories.

The set-top box STBm communicates with the gateway GTWm via a first communication module COMm and with the television TVm via a second communication module COMm2.

The first communication module COMm1 is, for example, a Wi-Fi link. The second communication module COMm2 is, for example, an HDMI link.

The set-top box STBm further comprises an HTTP adaptive streaming module HASm which is able to request for one of the content items to be streamed at one of the qualities proposed in a manifest MNF.

The set-top box STBm further comprises a management entity ENTm, which is one subject of the disclosure, the operation of which will be detailed below.

The set-top box STBm may also contain other modules such as a hard disk, which is not shown, for storing video segments, a module for controlling access to the content items, and a module for processing commands received from the smartphone.

FIG. 3 shows an architecture of a slave client terminal STBsi, also illustrated by means of a set-top box according to one embodiment of the disclosure. The architect of such a slave set-top box is the same as that described with reference to FIG. 2.

In particular, the set-top box STBsi conventionally comprises memories MEMsi associated with a processor CPUsi. The memories may be ROMs (read-only memories) or RAMs (random-access memories) or indeed flash memories.

The set-top box STBsi communicates with the gateway GTWsi via a first communication module COMsi1 and with the television TVsi via a second communication module COMsi2.

The first communication module COMsi1 is, for example, a Wi-Fi link. The second communication module COMsi2 is, for example, an HDMI link.

The set-top box STBsi further comprises an HTTP adaptive streaming module HASsi which is able to request for one of the content items to be streamed at one of the qualities proposed in a manifest MNF.

The set-top box STBsi further comprises a management entity ENTsi, which is one subject of the disclosure, the operation of which will be detailed below.

The set-top box STBsi may also contain other modules such as a hard disk, which is not shown, for storing video segments, a module for controlling access to the content items, and a module for processing commands received from the smartphone.

A schematic view of a main content item C1 divided into segments and stored in the content server SRV is now presented with reference to FIG. 4. More specifically, the content server HAS displays a video C1 in the form of segments C1i©Nj which are encoded at various encoding bit rates Nj, where the index i designates a temporal identifier of the segment C1i©Nj.

According to the prior art, the download module HAS, called the conventional download mode below, of the set-top box STB is responsible for retrieving the segments from the content server HAS by choosing the video quality Nj depending on the available network resources. The way in which the download module HAS chooses the bit rate at which the next video segment to be downloaded is encoded is not described in more detail here: indeed, there are many algorithms which make it possible to make this choice, the strategies of which are more or less secure or aggressive. It will, however, be recalled that, more often than not, the general principle of such algorithms is based on downloading a first segment at the lowest encoding bit rate proposed in the manifest, and on evaluating the time taken to retrieve this first segment. On this basis, the download module HAS evaluates whether, depending on the size of the segment and on the time taken to retrieve it, the network conditions make it possible to download the following segment at a higher encoding bit rate. Certain algorithms are based on gradually increasing the quality level of the downloaded content segments; others propose more risky approaches, with jumps in the levels of the bit rates at which successive segments are encoded.

In the conventional case, if a video segment lasts 3 seconds, it must not take the download module HAS more than 3 seconds to retrieve the segment, in order to make it possible for the set-top box STB to render the content item without interruption. The download module HAS should therefore make the best compromise between rendering quality, and therefore an encoding bit rate, which are as high as possible, and the time taken to download the segment, which must be short enough to make it possible to render it continuously on the television TV.

Initially, the module HAS retrieves the manifest MNF which corresponds to the video content item C1 in order to discover the available segments of the video content item C1, and the various associated video qualities Nj. In the example of FIG. 4, the content item C1 is, for example, offered in the form of segments of a duration of 3 s, with a first encoding bit rate N1=400 kb/s, a second encoding bit rate N2=800 kb/s, a third encoding bit rate N3=1200 kb/s, etc.

In a normal operating mode, which is not illustrated in FIG. 4, the module HAS downloads, for example, the successive segments C11@N1 (that is to say the first time segment at an encoding bit rate of 400 kb/s), then C12@N3 (that is to say the second time segment at an encoding bit rate of 1200 kb/s), then C13@N3 (that is to say the third time segment at an encoding bit rate of 1200 kb/s), etc.

The various segments downloaded by the download module HAS are transmitted to a display module AFF which is able to request for them to be displayed on the screen of the television TV.

The algorithm implemented by the download module HAS to determine which segment must be downloaded at which encoding bit rate in normal operating mode may be one of the already-existing algorithms from the prior art. This algorithm will therefore not be described in more detail here.

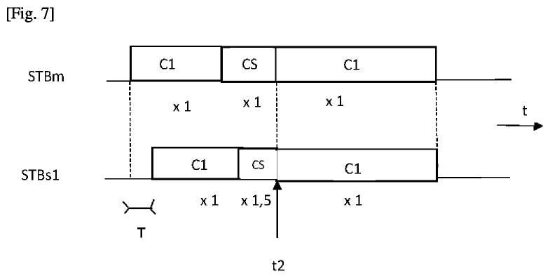

One embodiment of the method of the disclosure will now be described with reference to FIGS. 5 and 7.

In this embodiment, two set-top boxes STBm and STBs1 will access the same content item C1, and therefore the same segments, and will use a communication module to share comments on this content item C1.

It does not matter what communication module is used. The latter is, for example, a webcam associated with a social network application making it possible to communicate in real time with other users. In this example, a server VS manages the real-time communication by camera. Via this server VS, participants in a videoconference may communicate and comment on the rendering of a multimedia content item C1.

Instead of a videoconference, communication between participants may also be simply audio communication by landline phone or cell phone; in this case, the participants communicate in real time with one another by means of telephones in order to comment on the content item C1.

In general, an aspect of the present disclosure applies to the case where there is a time delay between a reference instant and the instant of rendering on this set-top box. As will be seen below, in this case an aspect of the present disclosure avoids situations in which users comment on images with a time interval. For example, during a sports competition such as a football match, because of an interval between the renderings on the television at one person's house and on the television of a neighbor, cries from neighbors announcing a goal are not acceptable in terms of user experience.

Below, it has been chosen to illustrate an aspect of the present disclosure by means of a videoconference. In this example, in order to simplify the disclosure, only two users UTm and UT1 will participate in the videoconference. With reference to FIGS. 2 and 3, the set-top boxes under consideration STBm/STBsi are equipped with cameras CAMm/CAMsi, respectively (i=1, 2). Each set-top box STBm/STBsi transmits a video stream captured by its camera and receives the video stream captured by the other camera.

In this videoconference context, if time intervals between the various renderings take place, the users viewing, for example, a match do not see the same scene at the same moment. If there is an interval of a few seconds between two renderings, there will be a time interval between two reactions with regard to the same scene (a goal, for example). The videoconference interaction then becomes chaotic, and all the more so the larger the number of set-top boxes is.

FIG. 5 illustrates phases PH1 and PH2 of the method according to one embodiment.

In this example, the content item C1 to be rendered is interspersed with secondary content items Cs such as advertisements or other similar content items.

During a first phase PH1, the set-top boxes STBm and STBs1 access the content item C1 in a default reading mode. The set-top boxes download the segments of the content item as indicated above according to the HAS download mode; each download module HASm/HASsi manages the downloading of the segments separately.

During this first phase PH2, the master set-top box STBm initiates a videoconference session and invites the slave terminal STBs1 to participate in it.

In this example, the slave set-top box STBs1 accepts and a videoconference session is activated.

At this stage, each screen TVm and TVs1 displays an image which is equivalent to that shown in FIG. 1. In this instance, the screens TVm and TVs1 then comprise a stream Fm or Fs1 according to the terminal under consideration. The master screen TVm shows the content item C1 and the stream linked to the videoconference originating from the slave set-top box STBs1; the screen TVm therefore shows the user UT1. Conversely, the slave screen TVs1 shows the content item C1 and the stream linked to the videoconference originating from the master set-top box STBm; the screen TVs1 therefore shows the user UTm.

During a first step ET1, the entities ENTm and ENTs1 present on the set-top boxes STBm/STBs1, respectively, determine latency delays T1 and T2, respectively.

In this example, the entity ENTm calculates the latency delay T1 by virtue of the manifest obtained during the first phase. In this example, the first latency delay T1 is calculated as often as possible so as to execute the following steps again. Thus, in this example, as soon as this first latency duration T1 undergoes a modification, the method is executed again. Specifically, interference may appear over time obliging the master terminal to modify, for example, the size of the buffer memory and therefore to modify the first latency duration T1.

In our example, recall that the latency delay before rendering corresponds to the delay between a given instant, for example the instant at which a segment is sent from the server SRV, and another instant, which may be the instant at which the same segment is sent to the television or even the instant at which this segment is rendered on the screen of the television.

In this example, in order to obtain the latency delay, the master entity ENTm consults the HAS manifest which indicates the exact predicted time at which the HAS segments of the live content item are produced and broadcast.

The master set-top box STBm determines, for a given segment which it has received, the time at which this segment was rendered on the master screen TVm. Having the broadcast time and the rendering time on the master terminal, the master set-top box STBm subtracts these two values and obtains a first latency delay before rendering T1. This latency delay makes it possible to obtain a real time interval between what is displayed on the screen and the “true” live broadcast (the time at which the segment is produced on the server SRV).

Having obtained the first latency delay T1, during a second step ET2, the master set-top box STBm transmits this latency delay T1 to the slave set-top box STBS1. The transmission is made, for example, via the server VS.

The slave entity ENTs1 performs the same calculation and obtains a second latency delay before rendering T2. The second latency delay is calculated on the same basis as the master terminal STBm, namely a latency delay between an instant at which a segment is broadcast and an instant at which it is rendered.

Having the latency delays T1 and T2 available, during a third step ET3, the slave entity ENTs compares the two latency delays T1 and T2. The rest of the method depends on the result of this comparison.

It should be noted that the slave terminal might compare the interval in the same way as the master terminal and decide, on this basis, to implement the method of the disclosure described below. However, as the aim is for the rendering on the televisions to be synchronous, it is more judicious to compare the latency delays T1 and T2.

If the latency delays T1 and T2 are the same or almost the same, in this case, the segments are downloaded without modifying the download mode.

Values will be defined for which it will be estimated that the difference between the latency delays T1 and T2 is such that the interval does not bother, or is not very visible to, the participants in the videoconference. For example, a difference of a few tenths of a second (for example, 0.1 second) will be tolerated; beyond this point processing is executed.

If the latency delays T1 and T differ by a duration of value T, with reference to FIG. 6 illustrating the prior art, without modifying the reading speed, the interval of duration T persists, or even worsens, throughout the reading by the set-top box STBs1. This figure, FIG. 6, shows two time axes associated with the set-top boxes STBm and STBs1, respectively. The set-top box STBm renders the content item C1 first and the set-top box STBs1 renders the same content item with a delay of duration T.

In this figure, FIG. 6, “×1” is a multiplier meaning that the reading is carried out at a normal speed.

In this same figure, FIG. 6, at an instant t, the set-top box STBm interrupts the rendering of the content item C1 and renders a secondary content item Cs instead. Such a secondary content item is, for example, a succession of advertisements.

In parallel, the set-top box STBs1, at an instant t+T, also interrupts the reading of the content item C1 and renders the secondary content item Cs, still with a delay T with respect to the master set-top box STBm. It is understood that the delay of duration T is present throughout the rendering of the content item C1 and of the secondary content item Cs on the set-top box STBs1. This time interval T between renderings leads to unmanageable videoconference discussions.

According to an aspect of the present disclosure, with reference to FIG. 7, when the latency delays differ by a given value, an entity ENTm and/or ENTs1, for example the entity ENTs1, performs processing so as to reduce this difference T between the two latency durations T1 and T2. In our example, the slave entity ENTs1 modifies the reading speed of the terminal at appropriate moments, in particular when the part of the main content item or a secondary content item is of little interest to the user. The user may, as such, define which content items, or which types of content items, have little value for them.

The modification of the speed may be applied, for example, to the opening credits or the closing credits of a film. Indeed, these parts are of little interest to the user and are often rendered but read by the user.

When the rendering of the main content item is interspersed with at least one secondary content item Cs, the modification of the speed may be applied, for example, to this secondary content item Cs or to part of this secondary content item Cs. For example, if the secondary content item is a series of advertisements, the speed at which all or some of the advertisements are read may be accelerated.

It is specified here that a secondary content item is, in this example, an unrequested content item, that is to say which is imposed by a third-party entity. This content item is, in some way, a content item which is not desired by the user of the terminal. It is understood here that a modification of the speed applied to an undesired content item will have no impact on the user viewing the content item, the latter not being a requested content item, unlike the main content item.

In FIG. 7, a multiplier (×1.5) makes it possible to accelerate the reading of the secondary content item Cs. If the speed is chosen judiciously, the reading of the content item C1 resumes at the instant t2 on each set-top box STBm and STBs1 with a normal reading speed (×1).

Advertisements to be read faster are chosen based on the preferences/tastes of the user. If the user likes motor vehicles and does not like fashion, the advertisements relating to motor vehicles are not accelerated, whereas the advertisements linked to fashion are accelerated.

Thus, two cases may present themselves with respect to the rendering of secondary content item Cs. Either the secondary content item is yet to be rendered or it is being rendered.

In the case where the secondary content item Cs has not started to be rendered and is therefore yet to be rendered, the entity ENTs1 suspends the processing to be applied, namely modifying the reading speed, until the moment when the secondary content item begins to be rendered. When the entity ENTs1 detects the instant at which the secondary content item is rendered, the entity applies a multiplier (×1.5) to the speed at which the secondary content item CS is read, in such a way as to accelerate the reading of the secondary content item CS and therefore to reduce, or even remove, the time difference T detected between the renderings on the televisions TVm and TVs1.

In FIG. 7, because of the accelerated reading of the secondary content item on the set-top box STBs1, the reading of the content item C1 resumes at the instant t2 without a time delay on this set-top box STBs1 with respect to the master set-top box STBm.

At this instant t2, the televisions TVm and TVs1 render the content item C1 without any interval or with very little interval.

According to one variant, the multiplier chosen may be dependent on the type of content item to be read. Depending on the type, the acceleration may be, for example, a gentle acceleration: ×1.1, a moderate acceleration: ×1.2, a harsh acceleration: ×1.5, or even a very harsh acceleration: ×2.

The secondary content item Cs may be a content item which is distinct from the main content item or included in the main content item.

For example, as indicated above, a secondary content item Cs, like the credits, which is included in a main content item is a part of the content item to be read. The modification of the speed may therefore target the credits, all the more so as this part is not always of interest to the user.

A modification of the reading may be an acceleration or a decrease according to the circumstances. When the entity is linked to a reading delay, an acceleration is necessary; conversely, when the reading is ahead on a reading terminal STBi, a decrease of the speed may be applied so as to resynchronize the renderings on the various reading terminals and thus ensure an optimal user experience.

In the example described above, the modification of the reading speed might have related to the entity ETm instead of the entity ETS1; in this case, the modification of the reading speed would have consisted in decreasing the speed rather than in increasing it.

The coefficients to be applied may also be defined by a user via a human-machine interface.

Concretely, the inventors found that, after forty-five minutes of a content item C1, for example a football match, being read, five seconds of latency delays with respect to the predicted rendering instant calculated by the content broadcaster are very often observed. An aspect of the present disclosure makes it possible to modify the reading speed of the set-top box so as to eliminate this five-second delay, for example during the half-time of a football match.

The entity ENTs1 may also accelerate the reading of sections of the match without any particular action, for example when an injured player is taken off.

If a multiplier of “×1.10” is selected, an acceleration applied to fifty seconds of a content item is sufficient to make up for the delay. In this instance, a half-time of a match lasts fifteen minutes, or nine hundred seconds; it is therefore necessary to accelerate 5.55% of the fifteen minutes of the half-time in order to resynchronize the reading between the two set-top boxes STBm and STBs1.

Another variant also consists in accelerating the transition delays between secondary content items which are read successively. Concretely, nowadays there are on average 45 advertisements during a half-time of a match. Accelerating each transition between advertisements would make it possible to save several seconds.

It is specified here that the modification of the reading speed, and by implication the chosen multiplier, is preferably chosen so that the modification of the reading speed remains not very or not perceptible to a user viewing the screen under consideration.

It should also be noted that the two entities may also contribute together to reducing the interval. Concretely, if the slave terminal STBs1 is 2 seconds behind the master terminal, by applying a multiplier of 0.75 to the reading speed on the master terminal STBm and a multiplier of 1.25 to the reading speed on the slave terminal STBs1, in this instance, the two-second time difference between the two renderings is made up for in 4 seconds. Concretely, labeling the reading speed on the set-top box STBm “Vm” (not labeled in the figures) and that on the set-top box STBs1 “Vs1”:
Vm×0.75 for 4 seconds of reading by STBm
Vs1×1.25 for 4 seconds of reading by STBs1

Specifically, accelerating by a coefficient of ×1.25 leads to 1.25 s of the content item to be read in 1 s, therefore 5 seconds of the content item are read in 4 seconds; and decelerating by a coefficient of ×0.75 leads to 0.75 s of the content item being read in 1 s, therefore 3 seconds of the content item are read in 4 seconds.

The symbol “x” used above is the mathematical multiplication sign.

It is specified lastly here that the term “entity” may correspond either to a software component or to a hardware component or to a set of software and hardware components, a software component itself corresponding to one or more computer programs or subroutines or, more generally, to any element of a program which is able to implement a function or a set of functions as described for the modules under consideration. In the same way, a hardware component corresponds to any element of a hardware assembly which is able to implement a function or a set of functions for the module under consideration (integrated circuit, chip card, memory card, etc.).

Although the present disclosure has been described with reference to one or more examples, workers skilled in the art will recognize that changes may be made in form and detail without departing from the scope of the disclosure and/or the appended claims.

1. A method comprising:
managing, in a terminal, reading of a multimedia content item, referred to as a main content item, with a view to rendering the main content item, the reading of the main content item being interspersed with a reading of a multimedia content item, referred to as a secondary content item, wherein the main content item and the secondary content item comprise time segments which may be received from a communication network (RES), and wherein the managing comprises:
a. requesting access to the main content item;
b. detecting an interval between an instant at which a segment of the main content item is rendered and a reference instant at which the same segment is rendered;
c. modifying a reading speed used by the terminal when the secondary content item is read.

2. The method according to claim 1, wherein the speed is modified in connection with part of the secondary content item.

3. The according to claim 1, wherein the speed used depends on the secondary content item to be read.

4. The according to claim 1, wherein, in response to the secondary content item not yet being rendered, postponing modifying the reading speed.

5. The according to claim 1, wherein the reference instant is an instant at which the same segment is rendered on another terminal.

6. The according to claim 1, wherein the reference instant is a predicted instant at which the same segment is rendered.

7. An entity comprising:
at least one processor; and
at least one non-transitory computer readable medium comprising instructions stored thereon which when executed by the at least one processor configure the entity to manage reading of a multimedia content item, referred to as a main content item, with a view to rendering the main content item, the reading of the main content item possibly being interspersed with a reading of a multimedia content item, referred to as a secondary content item, the main content item and the secondary content item comprising time segments which may be received from a communication network, and wherein the managing comprises:
a. requesting access to the main content item;
b. detecting an interval between an instant at which a segment of the main content item is rendered and a reference instant at which the same segment is rendered,
c. modifying a reading speed used by the entity when the secondary content item is read, the modifying being implemented in response to detecting the interval.

8. A reading terminal comprising the entity as defined in claim 8.

9. A non-transitory computer readable data medium on which at least one series of program code instructions has been stored for executing a managing method when the instructions are executed by at least one processor of a terminal, wherein the managing method comprises:
managing, in the terminal, reading of a multimedia content item, referred to as a main content item, with a view to rendering the main content item, the reading of the main content item being interspersed with a reading of a multimedia content item, referred to as a secondary content item, wherein the main content item and the secondary content item comprise time segments which may be received from a communication network (RES), and wherein the managing comprises:
a. requesting access to the main content item;
b. detecting an interval between an instant at which a segment of the main content item is rendered and a reference instant at which the same segment is rendered; and
c. modifying a reading speed used by the terminal when the secondary content item is read.
